(19) United States
(12) Patent Application Publication
(10) Pub. No.: US 2011/0161971 A1
(43) Pub. Date: Jun. 30, 2011

(54) Method and Data Processing Device for Processing Requests

(75) Inventor: Harsh JAHAGIRDAR, Bangalore (IN)

(73) Assignee: NOKIA CORPORATION, Espoo (FI)

(21) Appl. No.: 12/981,328

(22) Filed: Dec. 29, 2010

(30) Foreign Application Priority Data
Dec. 30, 2009 (IN) 3223/CHE/2009

(51) Int. Cl. G06F 9/46

(52) U.S. Cl. 718/103

(57) ABSTRACT

Disclosed are a data processing device, a method and a computer program product for processing requests in the data processing device. The data processing device includes at least one processor and at least one memory. The at least one memory includes a set of data including information for processing requests received from at least one client and computer program code, the at least one memory and the computer program code configured to, with the at least one processor, cause the data processing device at least to perform: notify, prior to processing a request, a client making the request to optionally update data associated with the request; and process the request based on the updated data, if the data is updated by the client.

### RELATED APPLICATIONS

This application claims priority to Indian Application No. 3223/CHE/2009 filed Dec. 30, 2009, which is incorporated herein by reference in its entirety.

### TECHNICAL FIELD

The present disclosure generally relates to processing of requests in data processing devices, and more particularly, to synchronizing of data associated with the requests, thereby efficiently handling the processing of requests in the data processing devices.

### BACKGROUND

Data processing devices such as mobile phones and other electronic devices support various applications that may enhance user experience while accessing the data processing devices. Examples of such applications include, but are not limited to, camera applications, audio applications, audio-video applications, text applications, network applications, and the like. Data processing devices also include various hardware components for supporting these applications. For example, an image capture/recording application may be supported by a camera, an audio application may be supported by a speaker and/or a microphone, and a video application may be supported by a display.

Typically, for executing an application in a data processing device, the user may provide an input. For example, for executing a video application, the user may operate a hard/soft key configured on the data processing device to play a video file. Further, data corresponding to the request may be stored in a repository in the data processing device that may be utilized for processing the request. For example, for a request to play a video file, various attributes of the video file may be stored in the repository such as length of the video file, format of the video file, and the like. The user may provide an input for playing the video file so that a corresponding request may be generated and processed, thereby resulting in the execution of the application in the data processing device. An application generating a request in a data processing device may hereinafter be referred to as a ‘client’.

Currently available data processing devices allows users to access numerous applications that are either already available on the device or downloaded from external sources such as the Internet. However, the conventional data processing devices possess limited hardware to support multiple requests generated by clients corresponding to these applications. Accordingly, these multiple requests are queued up and an order of priority may be assigned to each of the requests. Thereafter, the requests may be processed one by one in order of assigned priority. However, there may be a time delay between a time of generation of the request and the time when the processing begins. Accordingly, by the time the processing of the request begins, the data corresponding to the request stored in the repository may become invalid.

Moreover, in few instances, the user may wish to update the originally generated request with a new request. In such an instance, the originally generated request needs to be cancelled. For example, a user may wish to play a first scene of a video file. However, subsequently, the user may decide to play the video file from the third scene instead of the first scene. In such an instance, the user may be required to cancel the request of playing the video from the first scene, and submit the request for playing the video from the third scene. However, the cancellation of the previously generated request may or may not succeed depending on the state of the request processing in the data processing device. In case of an unsuccessful attempt for cancellation of a previously generated request, the data available for processing may not be synchronized with the data updated by the client for processing of the request, thereby resulting in transients in the execution of the applications.

In light of the above discussion, there is a need for synchronizing data to be utilized for processing requests in a data processing device, thereby efficiently processing any changes in client requests. Furthermore, there is a need for avoiding the occurrence of transients during execution of applications in the data processing device.

### SUMMARY

General purpose of various embodiments is to provide a method, a computer program product and a data processing device for processing requests.

Aspects of various embodiments provide processing of requests in a data processing device. The requests are made or generated in a data processing device by at least one ‘client’ and are processed by a data processing device. Each of these requests may have a set of data associated therewith, such that the processing of a request utilizes data from the set of data associated with said request. Prior to processing of the request, the ‘client’ may be notified with an option to update the data associated with the request. Based on the client's response, the request may be processed based on the updated data in case the data is updated by the client. However, in case, the client opts to retain the original data for processing the request, the said request may be processed based on the original data.

According to first aspect, a data processing device includes at least one memory and at least one processor. The at least one memory includes a set of data including information for processing requests received from at least one client and computer program code, the at least one memory and the computer program code configured to, with the at least one processor, cause the data processing device at least to perform: notify, prior to processing a request, a client making the request to optionally update data associated with the request; and process the request based on the updated data, if the data is updated by the client.

In an embodiment, the processor may be a Multi Media Resource Controller (MMRC) that may be configured to process the requests. The requests may be processed in order of priority assigned to each request. The processor may be configured to assign the priorities to each request. In an embodiment, the priority assigned to each request may be based on platform security capabilities, client type and run time conditions of each request.

According to second aspect, a method for processing requests in a data processing device is provided. The method includes storing a set of data in a memory of the data processing device. The data may have information for processing requests received from at least one client. Further, the method includes notifying by a processor, prior to processing a request, a client making the request to optionally update data associated with the request. Additionally, the request may be processed by the processor based on the updated data, if the data is updated by the client.

In an embodiment, the data associated with the requests may be multimedia data. The requests may be processed by the processor in order of priority assigned to each request. In an embodiment, the priority assigned to the each request may be based on platform security capabilities, client type, and run time condition of the each request. Further, the method may include processing the request based on original data associated with the request, if the data is not updated by the client.

According to third aspect, a computer program product for processing requests in a data processing device is provided. The computer program product includes at least one computer-readable storage medium, the computer-readable storage medium including a set of instructions configured to cause the data processing device to at least: store a set of data including information for processing requests received from at least one client; notify, prior to processing a request, a client making the request to optionally update data associated with the request; and process the request based on the updated data, if the data is updated by the client.

In an embodiment, the computer-readable storage medium includes a set of instructions for processing the requests in order of priority assigned to each request. The set of instructions for assigning priority to the each request may be based on platform security capabilities, client type, and run time condition of the each request. The computer-readable storage medium may further include a set of instructions for processing the request based on original data associated with the request, if the data is not updated by the client.

These and other features of the present disclosure will be apparent upon consideration of the following detailed description of preferred embodiments.

### BRIEF DESCRIPTION OF THE DRAWINGS

The above-mentioned and other features and advantages of various embodiments, and the manner of attaining them, will become more apparent and various embodiments will be better understood by reference to the following description taken in conjunction with the accompanying drawings, wherein:

FIG. 1 is a schematic representation of a software platform configured to support a data processing device, in accordance with an embodiment;

FIG. 2 is a block diagram of a data processing device, in accordance with an embodiment;

FIG. 3 is a block diagram of a data processing device, in accordance with another embodiment;

FIG. 4 is a block diagram of a data processing, in accordance with yet another embodiment; and

FIG. 5 is a flow diagram of a method for processing requests in a data processing device, according to an embodiment.

The method and data processing device have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Before describing in detail embodiments that are in accordance with the present disclosure, it should be observed that the embodiments reside primarily in combinations of method steps and data processing device components related to processing of requests.

In this document, the terms “comprises,” “comprising,” or any other variation thereof, are intended to cover a non-exclusive inclusion, such that a process, method, article, device or apparatus that comprises a list of elements does not include only those elements but may include other elements not expressly listed or inherent to such process, method, article, device, or apparatus. An element proceeded by “comprises . . . a” does not, without more constraints, preclude the existence of additional identical elements in the process, method, article, device or apparatus that comprises the element.

Any embodiment described herein is not necessarily to be construed as preferred or advantageous over other embodiments. All of the embodiments described in this detailed description are illustrative, and provided to enable persons skilled in the art to make or use the disclosure and not to limit the scope of the disclosure, which is defined by the claims.

The present disclosure provides a data processing device for processing requests, and a method therefor. The requests have a set of data associated therewith that may be utilized for processing the requests. The requests generated in the data processing device may be queued up, and a priority may be assigned to each of the requests. The priority assigned to the each request determines the order of processing of the corresponding request. Typically, due to the assigned priority, when processing of the request begins, there may be a time delay between the generation of the request and actual processing of the request. Due to said time delay, the data corresponding to the request may not be valid or may become outdated, and the request may still be processed utilizing the outdated data. The present disclosure precludes the need of utilizing the outdated data for processing requests, by providing an option to update the data associated with the request prior to commencing the processing of the request.

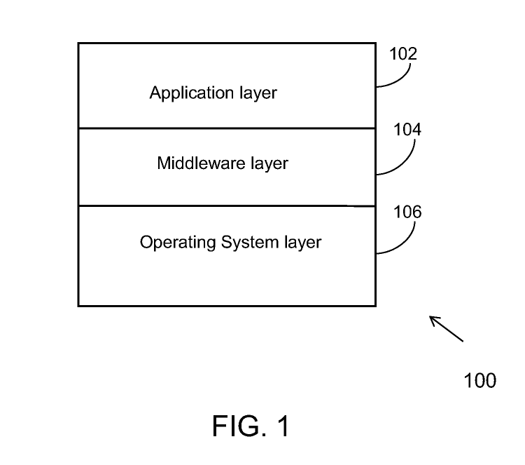

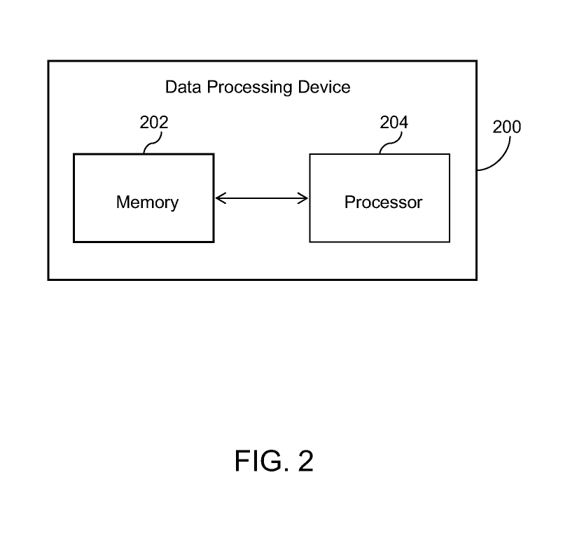

The teachings of the present disclosure may be implemented in a data processing device incorporating software and hardware platforms that are explained in detail in conjunction with FIGS. 1 and 2 respectively. Specifically, FIG. 1 is an exemplary schematic representation of software platform having a three-layered structure. Further, FIG. 2 is a block diagram of a data processing device capable of processing requests, in accordance with an embodiment.

Referring now to FIG. 1, a software platform 100 having a three-layered structure is presented. The three-layered architecture (or structure) includes an application layer 102, a middleware layer 104 and an Operating System (OS) layer 106.

The application layer 102 may primarily implement interactive User Interface (UI) applications. Such UI applications may provide an interface that allows their functionality to be accessed by other applications. The application layer 102 may enable a user to interact with the data processing device for accessing applications such as camera application, audio applications, audio-video applications, text applications, and the like. Moreover, the application layer 102 may support the extensibility or customization of various applications installed in the data processing device. The applications in the application layer 102 may be configured to make requests to the middleware layer 104. The applications and components thereof that may be capable of sending requests to the middleware layer 102 will hereinafter be referred to as ‘client’. Accordingly, for the purpose of this description, the terms ‘client’ and ‘application’ may be interchangeably used throughout the description without limiting the scope thereof.

The middleware layer 104 may provide Application Programming Interfaces (APIs) that may act as interface for allowing the software application in the application layer 102 to communicate with other software. The APIs of the middleware layer 104 may be configured to receive data processing requests from clients in the application layer 102.

Further, the OS layer 106 contains lower-level APIs that are used within the OS layer 106. The OS layer 106 defines plug-in interfaces for components that implement hardware adaptations. For example, the OS layer 106 may define plug-in interface for a camera, a microphone, a speaker, and the like configured in the data processing device. In a physical implementation, a processor may be associated with the OS layer 106 that is utilized for handling requests from various clients. The processor is further described in detail with help of FIGS. 2, 3 and 4. It will be understood that the software platform as shown and described herein is for description purpose only and should not be construed as limiting.

As disclosed herein, in order to access an application in the data processing device, a request may be submitted by a client in the application layer to the middleware layer, where the request is processed by the processor. Data processing devices (according to various embodiments) for processing requests are explained in detail in conjunction with FIGS. 2, 3 and 4.

Referring now to FIG. 2, a block diagram of a data processing device 200 is shown, in accordance with an embodiment. Examples of the data processing device 200 include communication devices, such as, mobile terminals, cellular phones, Personal Digital Assistants, handheld devices, and the like. Other examples, of the data processing device 200 may include electronic devices capable of processing requests, such as desktop computers, laptops, general or specific purpose computers, television, media players, and the like. The data processing device 200 may support software architecture as discussed in FIG. 1. Moreover, the data processing device 200 may have a plurality of applications configured therein that may be accessed by a user. Examples of such applications may include audio applications, video applications, audio-video applications, text applications, networking applications, and the like. The applications may be executed by submitting requests by the client in the data processing device 200. The requests may be associated with a set of data that may be utilized for processing the requests. Typically, the set of data may contain information for processing of the requests.

As disclosed herein, the data processing device 200 is shown to include includes a memory 202 and a processor 204. However, a person skilled in the art would appreciate that the data processing device 200 can include more than one memory and more than one processor. The memory 202 may be configured to store the set of data having information for processing requests received from at least one client and computer program code. For example, corresponding to a request received from a client to play a video file, the memory 202 may store location information, metadata information, and the like of the video file. In an embodiment, the data may be multimedia data, such as a video data, an audio data, and the like.

Further, each of the requests may have priorities associated therewith for their processing. Accordingly, in an embodiment, the memory 202 may be configured to store the priorities assigned to the each request. Herein, the term “priority” assigned to each request generally refers to an order of processing the request in the data processing device. A priority may be a value assigned to a request for example, in a table or other catalog of requests). The priority may also include a level or ranking assigned to each request without explicit assignment of a value to that request, such as by placing the request in a particular location within an ordered group or queue of the requests. By way of example, various attributes of a request affecting priority order thereof may include security capabilities of the software platform, a client type, run time conditions of the request, and the like. The security capabilities of the software platform may refer to various capabilities such as access to file systems, network connections, device drivers, accessibility options, of the data processing device. Further, the priority assigned to a request may be based on the type of client making the request. For example, a client may not possess a certain capability, such as capability to preferentially access multimedia devices, and accordingly may be assigned a lower priority as compared to another client possessing most of the capabilities to access the multimedia devices. Examples of different client types may include an audio client, a camera client, a telephony client, a video client, a text client, and the like.

The memory 202 may be a volatile memory or a non volatile memory. Examples of the one or more memory 202 include, but are not limited to, a hard drive, a Read Only Memory (ROM), a Random Access Memory (RAM), Erasable Programmable Read-Only Memory (EPROM), Electrically Erasable Programmable Read-Only Memory (EEPROM), Programmable Read-Only Memory (PROM), CD-ROM, or flash memory. The memory 202 may be permanently contained within the data processing device 200.

The processor 204 may be associated with the OS layer, such as the OS layer 106. The memory 202 and the computer program code can be configured to, with the processor 204, cause the data processing device 200, at least to notify a client making the request to optionally update data associated with the request, prior to processing the request. The requests may be queued up in a request queue, and a priority may be assigned to each request by the data processing device 200 such that the requests may be processed in order of priority assigned thereto. The memory 202 and the computer program code configured to, with the processor 204, cause the data processing device 200 to assign priority to the each request. For example, prior to processing the request, the memory 202 and the computer program code with the processor 204 can be configured to cause the data processing device 200 to send a notification to the client to optionally update the data associated with the request. The memory 202 and the computer program code configured to, with the processor 204, cause the data processing device 200 to process the request based on the updated data. However, the request may be processed based on the original data, if the data is not updated by the client.

Examples of one or more processor include, but are not limited to, one or more microprocessors, one or more processor(s) with accompanying digital signal processor(s), one or more processor(s) without accompanying digital signal processor(s), one or more special-purpose computer chips, one or more field-programmable gate arrays (FPGAs), one or more controllers, one or more application-specific integrated circuits (ASICs), or one or more computer(s).

As an example, consider that a request for processing is made by an audio client and another request by a camera application in the data processing device 200. Each of the two requests may be queued up in a request queue where a priority may be assigned to the each request. For example, the camera client may be assigned a higher order of priority as compared to the audio client. Accordingly, the request made by the camera application may be considered for processing prior to the request made by the audio application. The memory 202 and the computer program code configured to, with the processor 204, may cause the data processing device 200 to send a notification to the camera client to optionally update any data associated with the request, before processing the request from the camera client. For example, brightness setting, focus setting, zoom setting, color mode setting or any such setting of the camera application known in the art may be changed corresponding to the camera application. The changes in the data associated with the request made by the camera application may be updated in the memory 202 of the data processing device 200. The memory 202 and the computer program code configured to, with the processor 204, may cause the data processing device 200 to access the updated data stored in the memory 202 and process the request made by the camera application. Subsequently, the data processing device 200 may consider the request made by the audio application for processing based on an updated audio data if any, or original audio data.

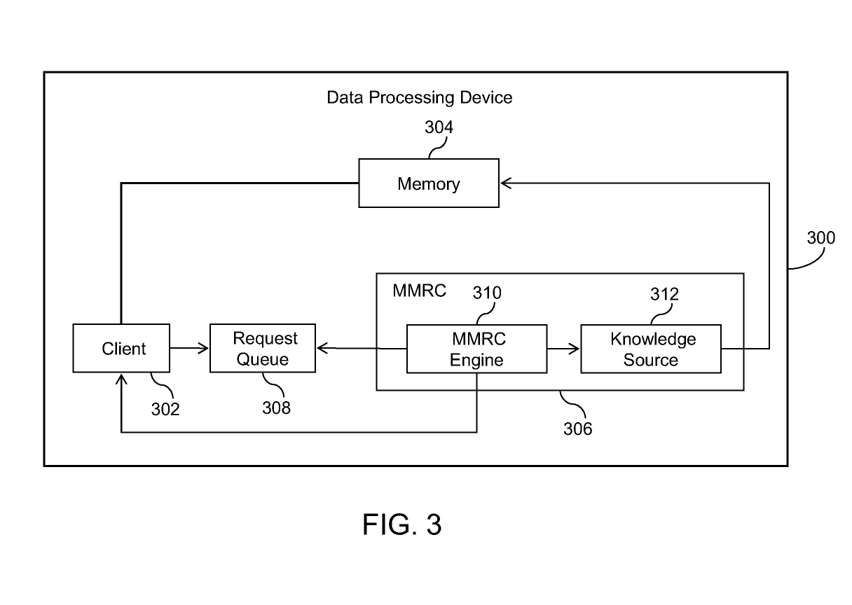

In an alternative embodiment, the processor 204 may be a Multi Media Resource Controller (MMRC). The embodiment having the processor 204 as the MMRC is described in conjunction with FIG. 3

FIG. 3 illustrates a block diagram of a data processing device 300 in accordance with another embodiment. The data processing device 300 may include at least one client such as a client 302, a memory such as a memory 304, and a processor such as a MMRC 306.

The at least one client may herein after be referred to as the client 302. The client 302 may be capable of making requests. The requests made by the clients such as the client 302 may be queued up in a request queue such as a request queue 308. The request queue 308 may be implemented as an independent component of the data processing device 300. Optionally, the request queue 308 may be implemented in the memory 304 of the data processing device 300.

The memory 304 may be configured to store a set of data associated with the requests queued up in the request queue. In an embodiment, the memory may be configured to store the priorities assigned to each of the requests. The memory 304 may be similar to the memory 202 (as explained with reference to FIG. 2), and accordingly, for the sake of brevity, herein the description of the memory 304 is omitted.

In the present embodiment, the MMRC 306 may include an MMRC engine 310 and one or more knowledge sources such as a knowledge source 312. The MMRC engine 310 may be configured to determine the order of priority of requests, and extract a request from the request queue 308 for processing based on said determination. The MMRC engine 310 may also be configured to notify the client 303 to optionally update the data (stored in the memory 304) associated with the request to be processed. Moreover, the MMRC engine 310 may be configured to forward the extracted request to the knowledge source 312. The knowledge source 312 may be configured to access data stored in the memory 304 of the data processing device 300, and subsequently process the request based on the accessed data.

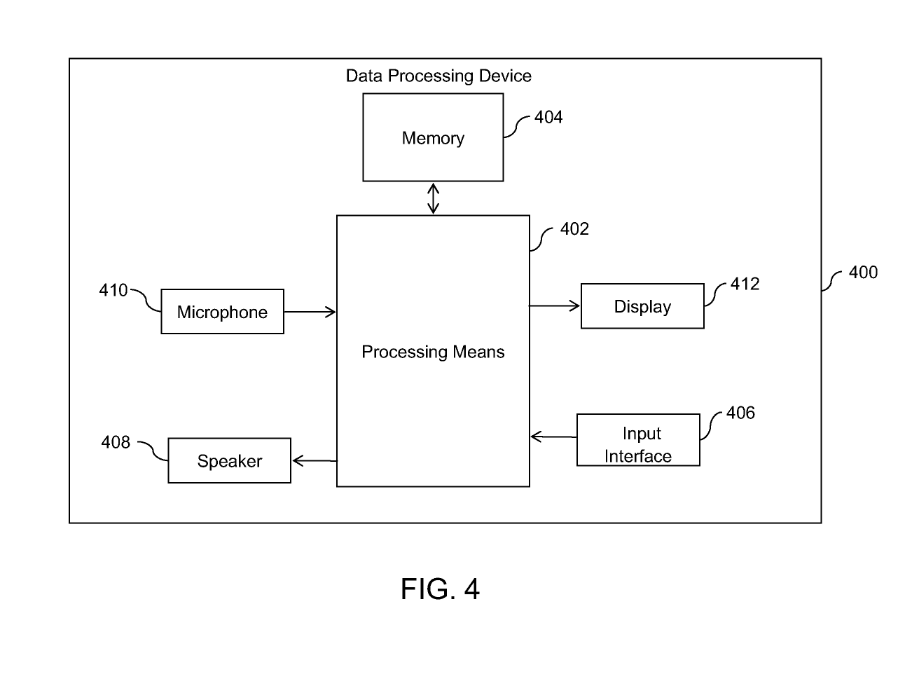

Reference is now made to FIG. 4, which illustrates a data processing device 400 for processing requests in accordance with yet another embodiment. The data processing device 400 may be an electronic computing device or a handheld device capable of processing requests made by applications, such as mobile applications or clients. The data processing device 400 may include various means for performing one or more functions in accordance with exemplary embodiments, including those more particularly shown and described herein. It should be understood that the data processing device 400 may include alternative means for performing one or more like functions, without departing from the spirit and scope of the present disclosure.

An entity capable of operating as data processing device (for example, the data processing device 200 or data processing device 400) may include means, such as a processing means 402 connected to a memory 404, for performing or controlling various functions of the entity. The processing means 402 may be a processing device, a processor, a controller or the like. The processing means 402 may notify a client making the request to optionally update data associated with the request, prior to processing the request. Further, the processing means 402 may process the requests based on the updated data or the original data, and may assign priority to the requests. Further, the memory 404 may comprise volatile and/or non-volatile memory and typically stores data having information pertaining to the requests made by the at least one client.

In addition to the memory 404, the processing means 402 may also be connected to at least one interface (such as an interface 406) or other means for displaying, and interacting with the data processing device 400 for sending a request. The interface may include at least one interface or other means for enabling interaction of a user with the data processing device 400. Such an interface may include a display and/or a user input interface. The user interface 406 may include any number of devices allowing the entity to receive input from a user by means of a keyboard, a touch display (not shown), or any other input peripheral device. Further, as shown in FIG. 4, the entity may include a speaker 408, a microphone 410, and a display 412 for receiving an output from the entity upon processing of the request.

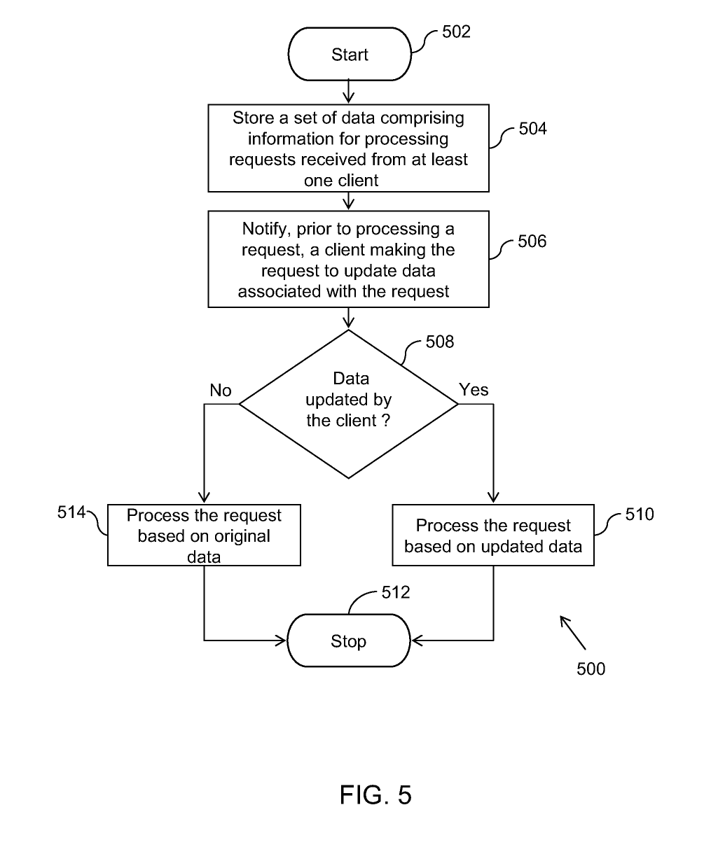

Referring now to FIG. 5, a flow diagram for a method 500 of processing requests in a data processing device, such as the data processing 200, 300 and 400 is illustrated, according to an embodiment. The method 500 for processing requests is explained by taking examples of the data processing device 200 having a memory 202 and a processor 204. However, it will be understood to a person skilled in the art that the method 500 is equally applicable for processing requests in other forms of the data processing device, such as the data processing device 300 and 400.

The method 500 for processing requests starts at 502. For example, at least one client makes requests for processing in the data processing device. The requests made by the at least one client is queued in a message queue. Typically, more than one request can be generated in the data processing device. As described, each of the requests may be assigned an order of priority, wherein the order of priority assigned to each request may determine the order of processing of said request. In an embodiment, the requests are processed by the processor, such as the processor 204.

At 504, a set of data may be stored that may include information for processing requests received from at least one client. In an embodiment, the set of data may be stored in a memory, such as the memory 202 of the data processing device 200. The set of data may include information corresponding to each request that may be utilized for processing the request. For example, for processing an audio request made by an audio client, the memory 202 may store metadata information, location information, duration information, and the like corresponding to the audio request.

At 506, a client making a request may be notified by a processor, for example, the processor 204, prior to processing a request. The client associated with the request may be notified with an option that may allow the client to update the data associated with the request, based on a priority order assigned to the request. For example, the request made by the audio client may be considered by the processor 204 for processing, based on the assigned priority. The processor 204 may notify the audio client to update the data associated with the request, prior to processing the request. The audio client may update the data stored in the memory 202, based on the notification.

At 508, it may be determined whether the data is updated by the client. In an embodiment, the determination may be made by a processor, for example, the processor 204. If the data is determined to be updated by the client at 508, the request may be processed by the processor 204 based on the updated data at 510. For example, the knowledge center may access the updated data for processing the request. Thereafter, the method 500 can be terminated at 512. If it is determined at 508 that the data is not updated by the client, the request may be processed by the processor 204 based on the original data at 514. Thereafter the method can be terminated at 512.

The present disclosure may take the form of a computer program product for detecting an object in a digital image, on a computer-readable storage medium having computer-readable program instructions (e.g., computer software) embodied in the computer-readable storage medium. Any suitable computer-readable storage medium (hereinafter ‘storage medium’) may be utilized including hard disks, CD-ROMs, RAMs, ROMs, Flash memories, optical storage devices, or magnetic storage devices.

The present disclosure is described above with reference to block diagrams and flowchart illustrations of method and processing device embodying the present disclosure. It will be understood that each block of the block diagram and flowchart illustrations, and combinations of blocks in the block diagrams and flowchart illustrations, respectively, may be implemented by a set of computer program instructions. These set of instructions may be loaded onto a general purpose computer, special purpose computer, or other programmable data processing apparatus to produce a machine, such that the set of instructions when executed on the computer or other programmable data processing apparatus create a means for implementing the functions specified in the flowchart block or blocks. Although other means for implementing the functions including various combinations of hardware, firmware and software as described herein may also be employed.

These computer program instructions may also be stored in a computer-readable medium that can cause a computer or other programmable data processing apparatus to function in a particular manner, such that the instructions stored in the computer-readable memory produce an article of manufacture including computer-readable instructions for implementing the function specified in the flowchart of the method 500. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart of the method 500.

Various embodiments of the present disclosure provide a data processing device such as the data processing device 200, 300, and 400; a method such as the method 500, and a computer program product for processing of requests in a data processing device. The method disclosed in 500 provides an option to a client to update the data associated with the request to be processed, prior to commencing the processing of the request. Such updation of the data associated with the requests helps in synchronizing data to be utilized for processing requests in a data processing device. As a result, the request is processed based on the updated data, thereby efficiently handling processing of changing client requests in a real time manner. Further, due to the processing of requests based on the updated data, any occurrence of transients during execution of applications in the data processing device is also avoided.

The foregoing descriptions of specific embodiments have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present disclosure.

What is claimed is:

1. A data processing device comprising:
at least one processor;
at least one memory comprising a set of data comprising information for processing requests received from at least one client; and
computer program code,
the at least one memory and the computer program code configured to, with the at least one processor, cause the data processing device at least to perform:
notifying, prior to processing a request, the at least one client making the request to update data associated with the request; and
processing the request based on the updated data, if the data is updated by the client.

2. The data processing device of claim 1, wherein the processor is a multi media resource controller.

3. The data processing device of claim 1, wherein the requests are processed in order of priority assigned to the requests.

4. The data processing device of claim 3, wherein the priority assigned to the requests is based on at least one of platform security capabilities, a client type, and a run time condition of the requests.

5. The data processing device of claim 1, wherein the at least one memory and the computer program code configured to, with the at least one processor, cause the data processing device at least to further perform:
assigning priority to the requests.

6. The data processing device of claim 1, wherein the data processing device is a hand-held device.

7. The data processing device of claim 1, wherein the data is multimedia data.

8. The data processing device of claim 1, wherein the at least one memory and the computer program code configured to, with the at least one processor, cause the data processing device at least to further perform:
processing the request based on original data associated with the at least one request, if the data is not updated by the client.

9. A method comprising:
receiving a set of data comprising information for processing requests received from at least one client;
notifying, prior to processing a request, the at least one client making the request to update data associated with the request; and
processing the request by a processor based on the updated data, if the data is updated by the client.

10. The method of claim 9, wherein the requests are processed in order of priority assigned to the requests.

11. The method of claim 10, wherein the priority assigned to the requests is based on at least one of platform security capabilities, a client type, and a run time condition of the requests.

12. The method of claim 9, wherein the data is multimedia data.

13. The method of claim 9 further comprising processing the request based on original data associated with the at least one request, if the data is not updated by the client.

14. The method of claim 9 further comprising assigning priority to the requests.

15. A computer program product comprising at least one computer-readable storage medium, the computer-readable storage medium comprising a set of instructions configured to cause the data processing device at least to perform:
receiving a set of data comprising information for processing requests received from at least one client;
notifying, prior to processing a request, the at least one client making the request to update data associated with the request; and
processing the request based on the updated data, if the data is updated by the client.

16. The computer program product of claim 15, wherein the set of instructions are further configured to cause data processing device at least to further perform:
processing requests in order of priority assigned to the requests.

17. The computer program product of claim 16, wherein the set of instructions are further configured to cause the data processing device at least to further perform:
assigning priority to the each request based on at least one of platform security capabilities, client type, and run time condition of the requests.

18. The computer program product of claim 15, wherein the set of instructions are further configured to cause the data processing device at least to further perform:
processing the request based on original data associated with the at least one request, if the data is not updated by the client.
